(19) United States
(12) Patent Application Publication
(10) Pub. No.: US 2015/0135655 A1
(43) Pub. Date: May 21, 2015

(54) SADDLE

(71) Applicant: Ursula Mayr, Bad Munstereifel (DE)

(72) Inventor: Ursula Mayr, Bad Munstereifel (DE)

(21) Appl. No.: 14/381,445

(22) PCT Filed: Dec. 6, 2012
(86) PCT No.: PCT/DE2012/100371

§ 371 Date: Jan. 29, 2015

(30) Foreign Application Priority Data
Dec. 23, 2011 (DE) 10 2011 122 260.3

(51) Int. Cl. B68C 1/02; B68C 1/12

(52) U.S. Cl. CPC B68C 1/02; B68C 1/12; B68C 1/025
USPC 54/44.5

(57) ABSTRACT

The present invention relates to a novel saddle for horses, consisting of a head iron (1) and a saddletree having a seat (2), saddle flaps (3) provided on both sides of said seat, sweat flaps (4) lying beneath said saddle flaps (3), a saddle pad (5), which lies on the back of the mount behind the shoulders thereof when the saddle is being used, and stirrup straps (6) lying on or under the saddle flaps (3) and being fastened to stirrup bars. The saddle is characterized in that, below the point of the head iron (1), the sweat flaps (4) have a rearward facing curved recess/cutback (40) and are padded over the entire area thereof. The recess of the sweat flaps according to the invention ensures that the saddle has absolute shoulder and muscle freedom, unobstructed lateral movement in stretch extension, and optimal flexibility at the rear owing to a special pad position described in detail hereafter, extending as far as at most the 18th thoracic vertebra.

### TECHNICAL FIELD

The present invention relates to a novel saddle for riding animals, in particular for horses, consisting of a head iron and a saddletree having a seat, saddle flaps provided on both sides of said seat, sweat flaps and saddle pads lying beneath said saddle flaps, said saddle pads lying on the back of the mount behind the shoulders thereof when the saddle is being used, and stirrup straps lying on or under the saddle flaps and being fastened to stirrup bars.

### PRIOR ART

The invention is based on the problem of trapezius muscle weakness and chronic stumbling, lack of relaxed release, pressure sensitivity of the lumbar vertebrae, and flexural stiffness in riding horses. This problem has actively emerged at the forefront in recent years owing to the ever-increasing proportion of smaller breeds of horses in the leisure area and the marked increase in riding time owing to an increase in available leisure time. At the same time, the proportion of female riders in the area of leisure riding has increased to greater than 70-80%, which has further increased awareness of the well-being of the horse as a “partner.” Just a few years ago, saddle lengths were still all much too long, extending far beyond the eighteenth rib, this still being the case for western saddles. Comfort and esthetic appearance on the part of the rider were in the forefront. Now, however, the health of the horse is more and more the focus of the rider.

The six basic rules of every classic basic training, 1. rhythm and 2. relaxed release, 3. contact and 4. impulsion, 5. collection and 6. straightness, could not be realized in a satisfactory manner by saddles used hitherto. These principles are interdependent to a high degree and cannot be separated. Nowadays, horses are used increasingly for leisure-time activities. The marked selective breeding of leisure-time horses in the direction of ease of riding is often no longer in accord with the tried and true standards. As a result of this, factors that serve to maintain health have come under pressure.

Nowadays there are a large number of horses that have in part dramatic back problems, which are due in large part to improper saddling. These back problems lead, in turn, to secondary problems in the limbs, chronic stumbling, a variety of postural and blockage damage, even organ damage. These problems cannot be eliminated by training or instruction as long as the cause, that is, the underlying problem, remains unchanged.

The associated muscle groups run along the skeletal framework and along the spinal column from head, neck, chest, withers, spinal column, sacroiliac bone to the tail and interact with one another. None of these muscle groups can work without the others. The groups of muscles and ligaments arranged laterally on the left and right run along the spinal column and costal arch like upstand and downstand beams and are responsible for stationary balance, straight-ahead movement, and dynamic balance. The spinous processes arranged above serve as points of attachment for ligaments and muscles and are connected from the front by the trapezius muscles to the forequarters and shoulders. As a result of this system, horses are naturally capable of bearing even great loads, that is, both the foal and amniotic fluid in the womb and the weight of a rider or pack load. The laterally running muscles (“downstand beams”) are responsible for handling forces that are created during movement. The so-called forward-downward movement then brings the back into an arched position that facilitates sway and expansive stepping under in the hindquarters and increases the load-bearing capacity of the spinal column during movement.

If, in this process, pressure points are created or if muscle portions atrophy, the horse will counter this pain or pressure by assuming a relieving posture. In this case, the horse will generally no longer arch its back to achieve full extension and load-bearing capacity, but will instead press its back downwards. The hindquarters can then no longer step under powerfully and thereby distribute the weight of the rider over the limbs. Following atrophy of the trapezius muscle, one back muscle yields more than the other when the horse takes a step and vice versa during the next step. The saddle tilts into the weaker half of the back, that is, alternately to the left and right. In the process, the center of gravity of the rider is shifted toward the left or right half of the body. Owing to the fastening of the saddle around the trunk of the horse by means of girths, the force acts as a lateral force also on the vertical spinous processes. As a result, the muscle portions and groups lying laterally adjacent to the spinous processes, which are actually intended to assist the momentum and locomotion, undergo a change of function to being purely stabilizing muscles. The problem is continuously aggravated, the tips of the shoulder blades project forward against the bottom saddle flap (sweat flap) during movement, and the triceps brachii muscle is less and less able or not at all able to bulge out.

### Principle of the Flexor and Extensor Muscle

The biceps brachii muscle has to contract to bend the forearm; it shortens and becomes more solid and markedly thicker so as to lift the forearm. In order to extend the forearm once again, the second muscle lying parallel to it is required, namely, the triceps brachii muscle. It is located on the back of the forearm. If it contracts in order to extend the biceps, it shortens and enlarges its surface area, which well-nigh rises and increases multifold in its expanse. To this end, it requires space, which hereinafter will also be referred to as the “zone of movement” behind the shoulder. This zone of movement, in particular, has to remain free. The bending function of the neck and shoulder (extension or longitudinal bending) as well as the bending function of the front flexibility (behind the first costal arches) and rear flexibility (behind the 18th rib) (lateral bending) may not be impaired if the horse is to move forward with the rider in an unimpeded manner and within the scope of its energetic potentials in a species-specific manner. When the shoulder musculature is improperly stressed or not free to move, the resulting strain is too great and continual atrophy of the trapezius muscle ensues and, as a result of this, overloading of the forequarters; the load-bearing capacity of the entire spinal column is ever increasingly reduced.

### Effects on the Neuroplexus

The “stellate ganglion,” an important neuroplexus for forequarter activity, represents a part of the so-called “sympathetic nervous system.” An inversion is accompanied by a block of the first rib and in part the forequarters and is due up to 90% to disturbance of the energy field. In the horse, the stellate ganglion lies on the left in the area of the first intercostal space on the longus colli muscle, divides in two on the right, and lies laterally against the trachea. This stellate ganglion supplies neck, forequarters (arm), heart, and lung with sympathetic nerve fibers. The following can be inferred from the anatomical description: Owing to the location of the stellate ganglion, it is not surprising that, when so-called “trapezius muscle atrophy” occurs, spinal and forequarter block ensues in this area.

Further stress due to a kind of compression of the broad lateral back muscle—latissimus dorsi muscle—in the case of conventional saddles with narrow shoulder pads acts like a “press block” all the way to the thoracolumbar fascia—thoracolumbar fascia muscle—as well as to the extension of the trapezius muscle. Oftentimes a clearly visible “compression crease” forms beneath the shoulder pad in the area of the broad lateral back muscle, this formation due to the lack of a smooth transition from shoulder pad to sweat flap.

### Further Consequences for the Nerval Structures

The nerval structures that arise due to elevated tonicity in the musculature undergo compression in the case of trapezius muscle weakness. Potential consequences may include sensory dysfunctions of the forelimbs, which are manifested in increased stumbling. It should not be forgotten that the continuously raised head-neck posture in certain kinds of gaits results in stenosis of the intervertebral foramen (exit opening of the spinal nerves) in this area. The spinal nerves that emerge there carry motor, sensory, and vegetative nerve fibers. Fibers of the phrenic nerve emerge from cervical segments five to seven.

Disturbances in this area are manifested further in complex coordination disorders and additional muscle weakness. Moreover, the vegetative nerve fibers may not be overlooked. Sympathetic fibers of the first seven thoracic vertebrae, which supply a vegetative ganglion (stellate ganglion), transmit their information to this ganglion.

Disturbances in this area are also manifested by elevated sympathetic tonicity. This often leads, among other things, to vascular stenosis. Further symptoms of elevated sympathetic tonicity may be increased sweating, agitation, anxiety, and an increase in pulse rate.

The greatest resulting problem for riders and horse is ultimately chronic stumbling of the horse due to contact of the saddle with this sensitive stellate ganglion plexus in the area of the head iron. This, in turn, is due to the deterioration of the trapezius muscle; that is, it is due to muscular atrophy. A chronic problem is created owing to the constant pressure applied to the triceps brachii muscle as well as the compressive pressure on the “broad back muscle” and the resulting reduction in metabolism in the muscle fibers, leading to overacidification of the muscle. In the initial transitory phase, horses attempt to adjust to this by compensation; that is, the rider does not take notice of it immediately.

### Consequences of Compensatory Behavior

It has been attempted hitherto only to solve this problem at what is effectively the end of the causal sequence of events, when the so-called compensatory behavior of the horse has already commenced, and not to remedy its cause. In compensatory behavior, the horse seeks to evade the pain or pressure point.

It moves in a cramped manner and alters its natural course of movement so as to find positions that avoid the pain. The consequence is that a compensating horse can never achieve its full performance, because energy is spent due to compensation and, owing to improper body posture, muscles may cramp and required muscles are not properly used. In the past (and in part to this very day), an attempt was made to treat this in a medical way. Thus, muscle fatigue in the pressure area due to deficient supply with blood, energy, oxygen, and protein was treated with gymnastic exercises, fitness training, and the administration of vitamin E, Equitop Myoplast (a muscle-building preparation), massages, use of solariums, magnetic field therapy, and acupuncture.

Training is certainly still an accompanying measure today, but the administration of medications becomes superfluous when attention is paid to the pressure points in the shoulder-free saddle concept. The same holds true for the length of the pads in the area of the lumbar spinal column.

The biomechanics of the spinal column of horses is impaired by the pressure points behind the eighteenth thoracic vertebra, because, on the one hand, no load-bearing capacity is ensured there any longer and, on the other hand, flexibility is impaired. The lumbar vertebrae one to five are regarded as the bending vertebrae of the back. If their bending is impeded and blocked by the saddle pads lying on both sides of the spinous processes and by the pressure applied by the rider's weight, the horse can no longer carry through its natural flow of movement. The biomechanics is blocked. Raising of the back in the lumbar area (referred to as an “overbuilt” back) is additionally detrimental in part to the possibility of stepping under, because, owing to the flow of movement during forward pacing, these areas require a strong flexibility. The horse compensates here, too, as described above.

### DESCRIPTION OF THE INVENTION

The present invention is based on the problem of creating a saddle for riding animals, in particular for horses, that provides the riding animal with active assistance in the formation, health maintenance, and correction of musculature of the back muscle groups of the horse as well as maintenance of healthy biomechanics.

The aforementioned problem is solved in accordance with the invention by the features of claim 1. Advantageous embodiments of the saddle according to the invention are presented in the dependent claims.

In accordance therewith, a saddle of the kind mentioned in the beginning is characterized in that, below the point of the head iron, the sweat flaps have a rearward facing curved recess.

The curved recess of the lateral pads on the sweat flaps according to the invention prevents the otherwise common “compression” of the triceps brachii muscles at the front behind the shoulder flap and, behind the flap, it ensures—especially in interaction with a preferred embodiment of the saddle pads described in detail below—a gentle, distributed pressure against the so-called “broad back muscle” when the saddle is girthed.

The saddle according to the invention alters, at once in front and behind, the time-honored so-called “English” saddle. In particular, in the case of the saddle according to the invention, the pressure points behind the shoulder pads on the lateral “broad back muscle”—latissimus dorsi muscle—which always still exist at the present time, are avoided, said pressure points causing a kind of “compression” of the costal pleura areas and these muscle areas lateral to the costal arches in the case of previous saddles. This avoidance is due to the fact that the saddle pads are arranged preferably beneath the entire sweat flap, as a result of which the horses feels the saddle to be especially comfortable, because the laterally lying “lateral broad back muscle” (latissimus dorsi muscle) experiences a uniformly distributed, laterally applied pressure. This pressure is necessarily present due to the buckling of the saddle by means of a girth as well as the lateral effect of the rider. The actual cause was thus not remedied for a long time, because it was assumed that this problem could not be solved by an alteration of the saddle.

Owing to the recess and large-area lateral padding according to the invention, the saddle ensures absolute freedom of movement of shoulders and muscles, unhindered lateral movement in stretch extension, and optimal flexibility in the rear due to a special pad position, described in detail hereinafter, extending as far as at most the eighteenth thoracic vertebra. This results in better running and more freely running horses as well as healthier horses, more dynamics, and more flowing and expansive movement, readier flexibility, and unimpeded biomechanics of the entire spinal column. The saddle according to the invention can be employed in principle in all riding disciplines.

### BRIEF DESCRIPTION OF THE DRAWINGS

Further objectives, features, advantages, and potential applications of the saddle according to the invention ensue from the following description of a number of embodiments based on drawings. Here, all described and/or graphically illustrated features constitute, in themselves or in any combination, the subject of the invention, regardless of their summary in individual claims or back references thereto.

Shown in the drawings are

FIG. 1, a saddle variant for small horses as well as for warm-blooded horses and full-blooded horses for dressage and leisure riding with different seat pads;

FIG. 2, a saddle variant for jumping horses;

FIG. 3, another saddle variant with third girth strap.

### IMPLEMENTATION OF THE INVENTION

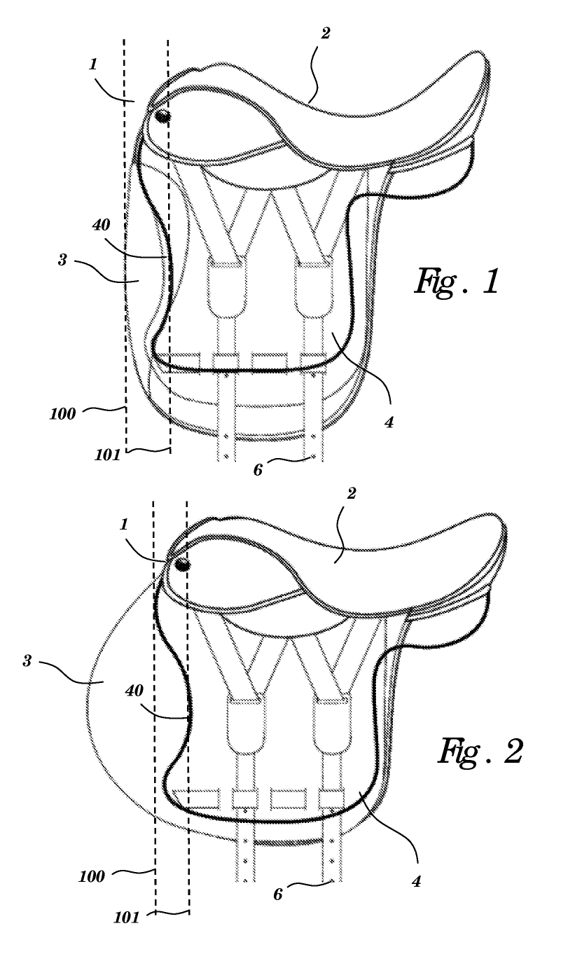

The advantageous, but in no way exclusive and hence exemplary implementation illustrated in FIG. 1 shows a saddle variant for small horses as well as for warm-blooded horses and full-blooded horses for dressage and leisure riding in an especially preferred embodiment of the invention with up to four seat forms (seat depths) and various seat pad variants (ribbed and smooth seat).

As can be seen from FIG. 1, the recess 40 is preferably designed such that the course of the sweat flap 4 is recessed starting approximately 1 to 3 cm below the point of the head iron 1 for approximately 12 cm below the edge of the pad, for example, in a radius of approximately 5 cm up to the imaginary line 101, which runs approximately 3 to 5 cm behind the imaginary vertical line 100. The saddle pad 5, which begins or rests laterally behind the horse shoulder, is preferably recessed over a length of up to 14 to 15 cm by this value. At 4 to 6 cm before the bottom end of the sweat flap 4, the recess leads back again 2.5 cm in the direction of the imaginary vertical line 101, but ends about 2 cm before this line 101.

The course of the sweat flap 4 is thus recessed by approximately 6 to 6.5 cm behind the saddle flap 3, because the saddle flap 3 preferably extends approximately 1.5 cm beyond the seat flap 3 on each side. As a result of this, no “compression” is created behind the saddle pad 5 and there is only a gentle—because of its distribution—pressure against the broad back muscle when the saddle is girthed.

In the area of the sweat flap 4, the saddle pad 5 starts with the shoulder area and extends all the way to the back and lower end of the sweat flap 4, but tapers to a thickness of 10 mm. From the area of back contact on, the saddle pad 5 tapers in the direction of the sweat flap 4, so that, here, there is a pad thickness of approximately 25 to 30 mm.

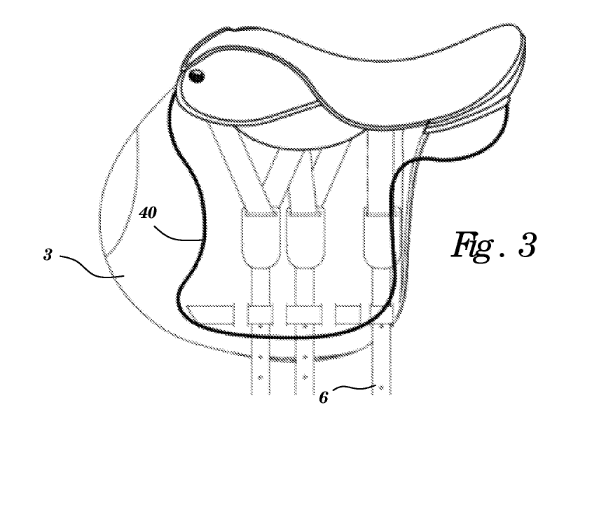

FIG. 2 shows a saddle variant for jumping horses. As can be seen from FIG. 2, the recess 40 in this embodiment is preferably designed such that the sweat flap 4 is recessed starting approximately 2 to 3 cm below the point of the head iron 1 for approximately 14 cm to 15 cm, for example, below the edge of the pad, in a radius of approximately 5 cm up to the imaginary line 101, which runs approximately 4 to 6 cm behind the imaginary vertical line 100. The saddle pad 5, which begins or rests laterally behind the shoulders of the horse is preferably recessed over a length of up to 16 to 17 cm by this value. At 6 to 7 cm before the bottom end of the sweat flap 4, the recess leads back again in the direction of the imaginary vertical line 101, but can also extend, together with the saddle flap 3 (in the case of the thicker pad design) all the way to front edge thereof; at the front and below, the saddle flap 3 extends approximately 1.5 cm beyond the edge of the sweat flap 4 or the saddle pad 5.

In the area of the front part of the sweat flap, the pad starts at the shoulder area and extends all the way to the back and lower end of the sweat flap 4, but tapers to a thickness of 10 mm. As a result, no “compression” is created behind the shoulder pad and there is only a gentle—because of its distribution—pressure against the broad back muscle when the saddle is girthed. From the area of back contact on, the saddle pad 5 tapers in the direction of the sweat flap 4, so that, here, there is a pad thickness of approximately 25 to 30 mm.

The variable girthing is accomplished by a permanently fixed and a variable strap design or, optionally, by a design with two variable straps (so-called V-girthing), which can be fitted or adjusted in the bottom area of the sweat flap in strap attachment loops on the trunk of the horse. As can be seen from FIG. 3, a third girthing strap lying further back is also possible.

Owing the wide recess of the saddle pad form beginning at the front, it is ensured that both the deltoid muscle (triceps brachii muscle) and also the zone of movement of the shoulder required behind it remain free and can work unimpeded.

In the embodiment from FIG. 2, the saddle flap 3 and, if need be, also the sweat flap 4 project forward by approximately 12 to 17 cm. In order to ensure the requirement stiffness in this case, inlays made of carbon or alternatively plastic are embedded in the saddle flap 3 and/or the sweat flap 4 for reinforcement. In this way, it is ensured that the rider, when seated with short stirrups and a strongly forward-leaning posture, does not stress the shoulder muscle area during jumping.

All variants are possible both with wool-stuffed pads and French pads. The head irons may have a rigid, an interchangeable, or else an adjustable design.

### LIST OF REFERENCE NUMBERS

1 head iron
2 seat
3 saddle flap
4 sweat flap
5 saddle pad
6 stirrup straps
40 recess of the sweat flap

1. A saddle for horses, consisting of a head iron (1) and a saddletree having a seat (2), saddle flaps (3) provided on both sides of said seat, sweat flaps (4) lying beneath said saddle flaps (3), a saddle pad (5), which lies on the back of the mount behind the shoulders thereof when the saddle is being used, and stirrup straps (6) lying on or under the saddle flaps (3) and being fastened to stirrup bars,
characterized in that,
below the point of the head iron (1), the sweat flaps (4) have a rearward facing curved recess/cutback (40).

2. The saddle according to claim 1,
further characterized in that
the saddle pad (5) beginning or resting laterally behind the horse's shoulder is recessed over a defined length.

3. The saddle according to claim 1,
further characterized in that p1 the course of the sweat flap (4) is recessed behind the saddle flap (3) over a defined area, with the periphery of the saddle flap (3) preferably extending beyond the sweat flap (4).

4. The saddle according to claim 1,
further characterized in that
the saddle pad (5) begins in the area of the sweat flap (4) at the shoulder area and extends to the back and bottom end of the sweat flap (4) and tapers to a defined thickness.

5. The saddle according to claim 1,
further characterized in that
the saddle pad (5) tapers to a defined thickness from the area of contact with the back to the sweat flap (4).

6. The saddle according to claim 1,
further characterized in that
a variable girthing is accomplished by a permanently fixed and a variable strap design or, optionally, by a design with two variable straps (so-called V-girthing), which can be fitted or adjusted in the bottom area of the sweat flap in strap attachment loops on the trunk of the horse.

7. The saddle according to claim 1,
further characterized in that
a wide recess of the saddle pad form is provided starting in front, the effect of which is to ensure that both the deltoid muscle (triceps brachii muscle) and also the zone of movement of the shoulder required behind it remain free and can work unimpeded.

8. The saddle according to claim 1,
further characterized in that
the saddle flap (3) and/or the sweat flap (4) project forward by a defined width—of preferably 16 to 17 cm—with inserts made of carbon or alternatively plastic being embedded in the saddle (3) and/or the sweat flap (4) for reinforcement.
